(19) United States
(12) Patent Application Publication
(10) Pub. No.: US 2007/0268883 A1
(43) Pub. Date: Nov. 22, 2007

(54) Radio text plus over digital video broadcast-handheld

(75) Inventors: Hans-Christoph Quelle, Dusseldorf (DE); Markku Soinio, Espoo (FI); Timo Karras, Espoo (FI)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 11/434,757

(22) Filed: May 17, 2006

(51) Int. Cl. H04J 3/24; H04J 1/02

(52) U.S. Cl. 370/349; 370/493

(57) ABSTRACT

Provided are apparatuses and methods for transmitting radiotext plus data (e.g., RT+ data) to a mobile terminal. In one example, radiotext plus data is received and transmitted to the mobile terminal in a Digital Video Broadcast—Handheld (DVB-H) data stream. Program or service data corresponding to a program may be endoded on IP and transmitted in audio/video data in a DVB-H data stream and RT+ data corresponding to the program may be transmitted on Internet Protocol (IP). For example, the RT+ data may be converted to Real-Time Transport Protocol (RTP) on a RTP timed text protocol. In another example, a content stream may be received and divided into a program data stream and a corresponding RT+ data stream. The RT+ data stream may be converted to RTP and synchronized with the program data on audio/video data in a DVB-H data stream. The RT+ data may be delivered to a mobile terminal.

### FIELD OF THE INVENTION

The invention relates generally to communications networks. More specifically, the invention relates to providing data in a data stream.

### BACKGROUND OF THE INVENTION

Digital broadband broadcast networks enable end users to receive digital content including video, audio, data, and so forth. Using a mobile terminal, a user may receive digital content over a wireless digital broadcast network. For example, a user may receive data such as a broadcast program in a data stream. Additional data associated with the broadcast program may also be desired such as program title, news, interactive services, or additional related information. Much of the information desired may include information that changes over time. Hence, a mobile terminal user may wish to receive information associated with a broadcast program that is up-to-date such as information updated and provided in real-time.

Thus, a system and method is needed for providing information messages corresponding to a digital broadcast program to a mobile terminal user. For example, there exists a need in the art for a method and system for providing a mobile television or audio user additional information and interactive services related to a television program on a display.

### BRIEF SUMMARY OF THE INVENTION

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the more detailed description below.

In one example, a method is provided for transmitting radiotext plus data (RT+ data) corresponding to a program or service to a mobile terminal. For example, RT+ data may be transmitted to a mobile terminal in a Digital Video Broadcast—Handheld (DVB-H) data stream.

In another example, the RT+ data is converted to RTP (Real-Time Transport Protocol) on Internet Protocol (IP) and the converted data is transmitted in a DVB-H data stream. The converted RT+ data is synchronized with the DVB-H audio/visual stream and delivered to a mobile terminal.

In another example, the RT+ data is converted to RTCP (Real Time Control Protocol) packets and the converted data is transmitted in a DVB-H audio and/or video stream. The RT+ data is synchronized the DVB-H audio and/or visual stream and delivered to a mobile terminal.

In another example, a content data stream is received and divided into a program data component and a RT+ data component. The program data component is encoded in a DVB-H stream and the RT+ data component is converted to RTP or RTCP and synchronized with the program data.

In another example, a transmission system is provided for transmitting RT+ data to a mobile terminal. The RT+ data may be converted to RTP or RTCP and may be synchronized with corresponding program data on a DVB-H stream.

In another example, a receiver is provided for receiving RT+ data over RTP or RTCP and associated DVB-H program data and presenting the data in a synchronized manner. In another example, the receiver may include a control unit to create a user interface (UI) based on information or instructions in the RT+ data stream.

In yet another example, a computer-readable medium is provided for transmitting program data and corresponding RT+ data over RTP or RTCP to a mobile terminal. In one example, the program data and the RT+ data is synchronized in a DVB-H stream.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates a suitable digital broadband broadcast system in which one or more illustrative embodiments of the invention may be implemented.

FIG. 2 illustrates examples of item content categories in accordance with an aspect of the present invention.

FIG. 3 illustrates examples of info content categories in accordance with an aspect of the present invention.

FIG. 4 illustrates examples of information of a program class of a content type in accordance with an aspect of the present invention.

FIG. 5 illustrates examples of elements in an interactivity class in accordance with an aspect of the present invention.

FIG. 6 illustrates another example of the content type including a descriptor class in which additional descriptive information may be provided in accordance with an aspect of the present invention.

FIG. 7 illustrates an example of bit allocation for transmitting the RT+ data in accordance with an aspect of the present invention.

FIG. 8 illustrates an example of message bits of an RT+ application group in which a pair of RT+ tags are conveyed in accordance with an aspect of the present invention.

FIG. 9 is a partial block diagram illustrating an example of a system for transmitting RT+ data over DVB-H to a mobile terminal in accordance with an aspect of the present invention.

FIG. 10 is a partial block diagram illustrating an example of a receiver or mobile terminal in accordance with an aspect of the present invention.

FIG. 11 illustrates a block diagram of a mobile terminal in accordance with an aspect of the present invention.

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

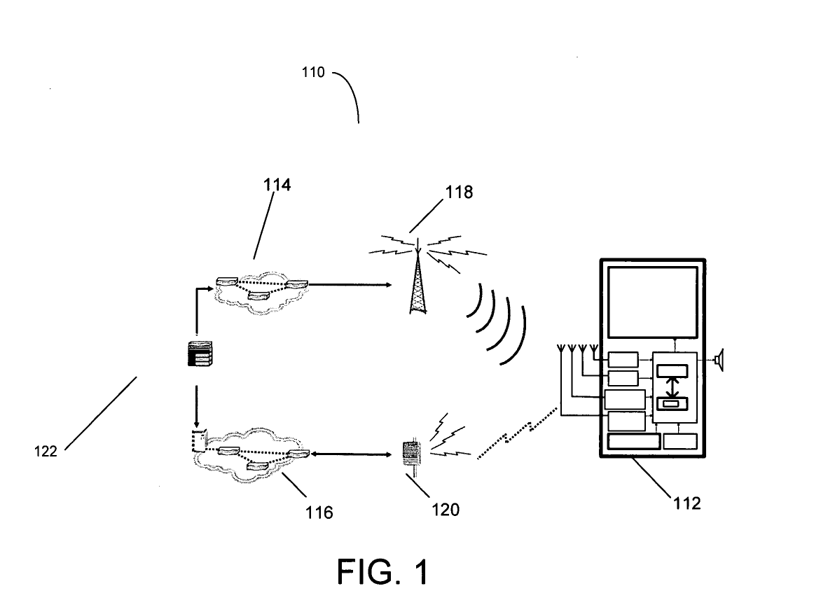

FIG. 1 illustrates an example of a wireless communication system 110 in which the systems and methods of the present invention may be advantageously employed. One or more network-enabled mobile devices 112, such as a personal digital assistant (PDA), cellular telephone, mobile terminal, personal video recorder, portable television, personal computer, digital camera, digital camcorder, portable audio device, portable radio, or combinations thereof, are in communication with a service source 122 through a broadcast network 114 and/or cellular network 116. The mobile terminal/device 112 may comprise a digital broadcast receiver device. The service source 122 may be connected to several service providers that may provide their actual program content or information or description of their services and programs to the service source that further provides the content or information to the mobile device 112. The several service providers may include but are not limited to one or more television and/or digital television service providers, analog and/or digital AM/FM radio service providers, SMS/MMS push service providers, Internet content or access providers.

The broadcast network 114 may include a radio transmission of IP datacasting over DVB and/or DVB-H. The broadcast network 114 may broadcast a service such as a digital or analog television signal and supplemental content related to the service via transmitter 118. The broadcast network may also include a radio, television or IP datacasting broadcasting network. The broadcast network 114 may also transmit supplemental content which may include a television signal, audio and/or video streams, data streams, video files, audio files, software files, and/or video games. In the case of transmitting IP datacasting services, the service source 122 may communicate actual program content to user device 112 through the broadcast network 114 and additional information such as user right and access information for the actual program content through the cellular network 116.

The mobile device 112 may also contact the service source 122 through the cellular network 116. The cellular network 116 may comprise a wireless network and a base transceiver station transmitter 120. The cellular network may include a second/third-generation (2G/3G) cellular data communications network, a Global System for Mobile communications network (GSM), or other wireless communication network such as a WLAN network.

In one aspect of the invention, mobile device 112 may comprise a wireless interface configured to send and/or receive digital wireless communications within cellular network 116. The information received by mobile device 112 through the cellular network 116 or broadcast network 114 may include user selection, applications, services, electronic images, audio clips, video clips, and/or WTAI (Wireless Telephony Application Interface) messages. As part of cellular network 116, one or more base stations (not shown) may support digital communications with receiver device 112 while the receiver device is located within the administrative domain of cellular network 116.

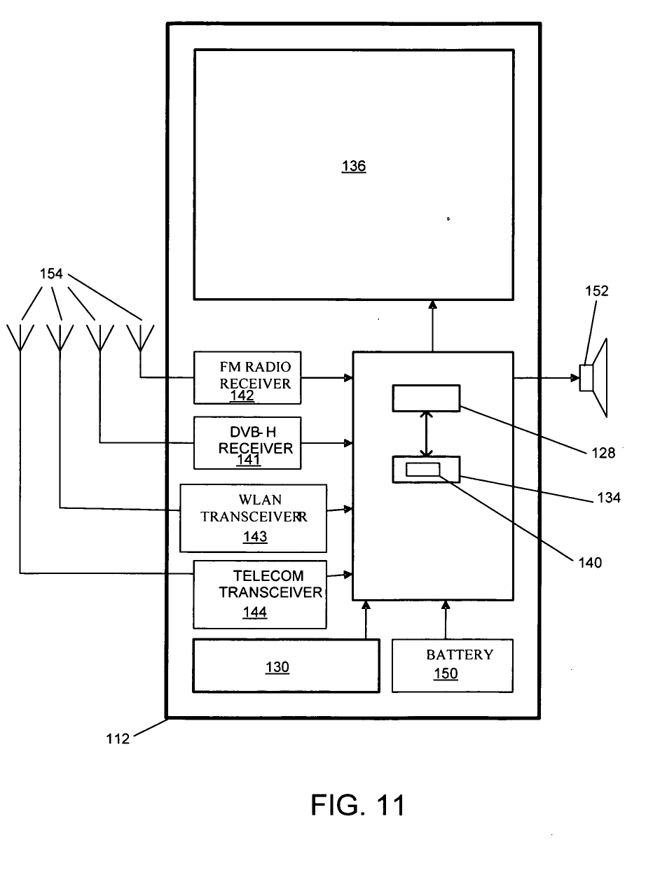

As shown in FIG. 11, mobile device 112 may include processor 128 connected to user interface 130, memory 134 and/or other storage, and display 136. Mobile device 112 may also include battery 150, speaker 152 and antennas 154. User interface 130 may further include a keypad, touch screen, voice interface, one or more arrow keys, joy-stick, data glove, mouse, roller ball, touch screen, voice interface, or the like.

Computer executable instructions and data used by processor 128 and other components within mobile device 112 may be stored in a computer readable memory 134. The memory may be implemented with any combination of read only memory modules or random access memory modules, optionally including both volatile and nonvolatile memory. Software 140 may be stored within memory 134 and/or storage to provide instructions to processor 128 for enabling mobile device 112 to perform various functions. Alternatively, some or all of mobile device 112 computer executable instructions may be embodied in hardware or firmware (not shown).

Mobile device 112 may be configured to receive, decode and process transmissions, based on the Digital Video Broadcast (DVB) standard, such as DVB-H or DVB-MHP, through a specific DVB receiver 141. Additionally, receiver device 112 may also be configured to receive, decode and process transmissions through FM/AM Radio receiver 142, WLAN transceiver 143, and telecommunications transceiver 144. In one aspect of the invention, mobile device 112 may receive messages via radio data system (RDS).

In an example of the DVB standard, one DVB 10 Mbit/s transmission may have 200, 50 kbit/s audio program channels or 50, 200 kbit/s video (TV) program channels. The mobile device 112 may be configured to receive, decode, and process transmission based on the Digital Video Broadcast-Handheld (DVB-H) standard or other DVB standards, such as DVB-MHP, DVB-Satellite (DVB-S), DVB-Terrestrial (DVB-T) or DVB-Cable (DVB-C). Similarly, other digital transmission formats may alternatively be used to deliver content and information of availability of supplemental services, such as ATSC (Advanced Television Systems Committee), NTSC (National Television System Committee), ISDB-T (Integrated Services Digital Broadcasting—Terrestrial), DAB (Digital Audio Broadcasting), DMB (Digital Multimedia Broadcasting) or DIRECTV. Additionally, the digital transmission may be time sliced, such as in DVB-H technology. In this case the mobile device 112 may have one or more buffer memories for storing the decoded time sliced transmission before presentation.

In one example, information corresponding to a digital broadcast program may be provided to a user terminal. For example, a mobile user terminal may receive data associated with a digital broadcast program such as a program title, news, interactive services, news, web addresses associated with the program, etc. The information may be provided as text messages (e.g., Radiotext plus (RT+) messages) and may further be stored at the mobile terminal. In this example, the RT+ messages include metadata associated with a corresponding program and may be carried in parallel to the program data. The metadata corresponding to the RT+ messages may be tagged such that the RT+ messages may be read by a receiver. In an example of the invention, RT+ messages may be provide metadata associated with program content in DVB-H broadcasting.

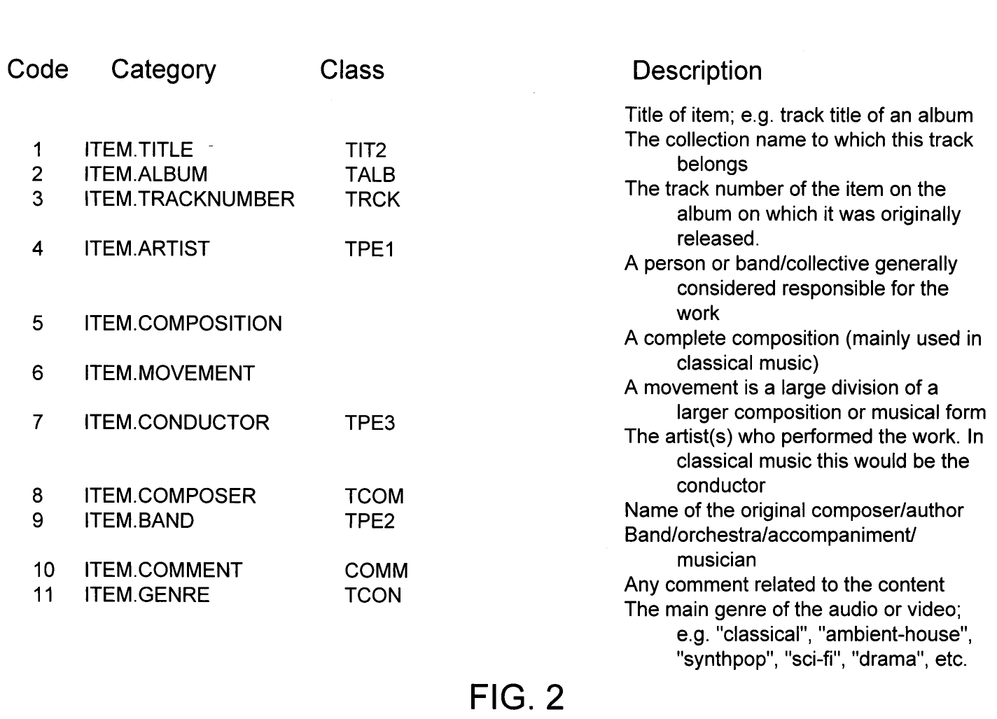

In this example, the data associated with the digital broadcast program may be included in one or more radiotext plus (RT+) tag. The RT+ tag may contain a message informing a user of information of relevance to the accompanying program, for example, a title of a song or program, an artist or performer name, etc. The RT+ tag may contain different fields for providing relevant information. For example, the RT+ tag may contain a content type field in which the type of the content is provided. There are many categories of content types for describing the relevant information. For example, the content type may include an item category as illustrated in FIG. 2, in which one or more illustrative embodiments of the invention may be implemented. FIG. 2 illustrates examples of item category information that may be included in an RT+ tag. An item may include any division of a program. For example, in an audio program, an item may be a song. In a video broadcast, an item may be a television program. An item may be described by any one of several classes. As the FIG. 2 example illustrates, an item category may include a title of the item, a name of an album or collection that the item belongs, a track number of the item on an album, an artist associated with the item (e.g., a performer, director, etc.), a composition (e.g., for classical music), a movement within a larger musical item (e.g., a movement within a symphony or concerto), performing artist (e.g., conductor of a symphony), composer or author, band or orchestra, genre of the item, or comments related to the content.

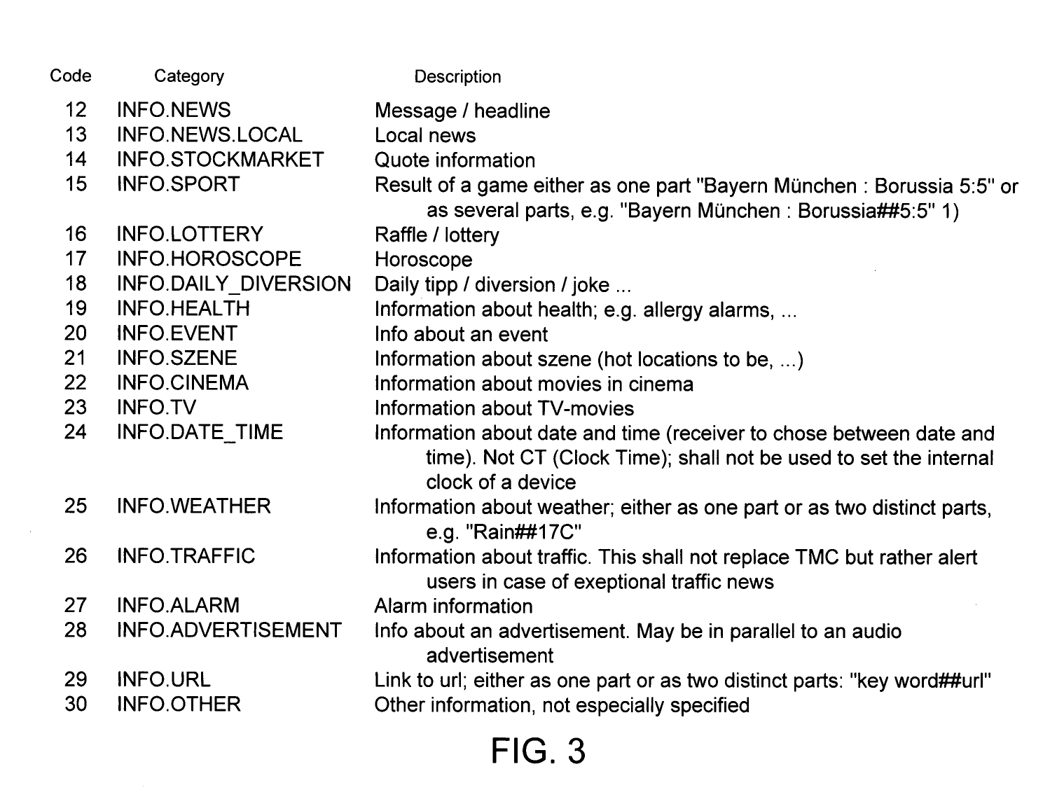

An info class is another example of a class of content type. FIG. 3 illustrates examples of info content categories, in which one or more illustrative embodiments of the invention may be implemented. In this example, the info class may include a message providing a news headline or message, information on local news, stock market quote information, information on a sporting event, raffle or lottery information, a horoscope, a daily tip or joke, health information (e.g., allergy alerts), any information regarding any event of interest, information of popular destinations or hot spots, information on films, information about television programs, information about date and time, weather information, traffic information, alarm information, advertisement information, a link to a URL, or any other relevant information such as textual service information of interest to the user.

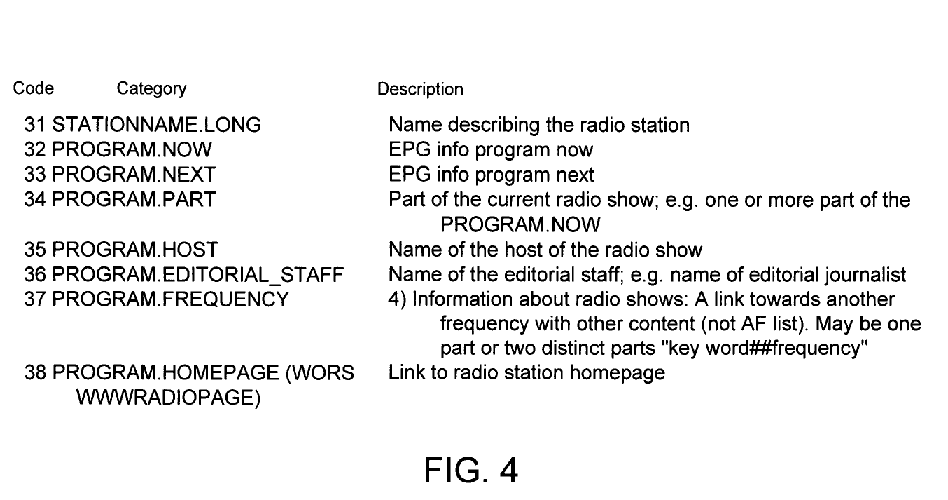

The content type may also include information of a program class which may describe the program service. FIG. 4 illustrates an example of information of a program class of a content type, in which one or more illustrative embodiments of the invention may be implemented. For example, the program class information may include a radio or television station name, current program information, subsequent program information, information on a host, performer or editorial staff of a program, a frequency at which the program is broadcast, or a link to a homepage of the station.

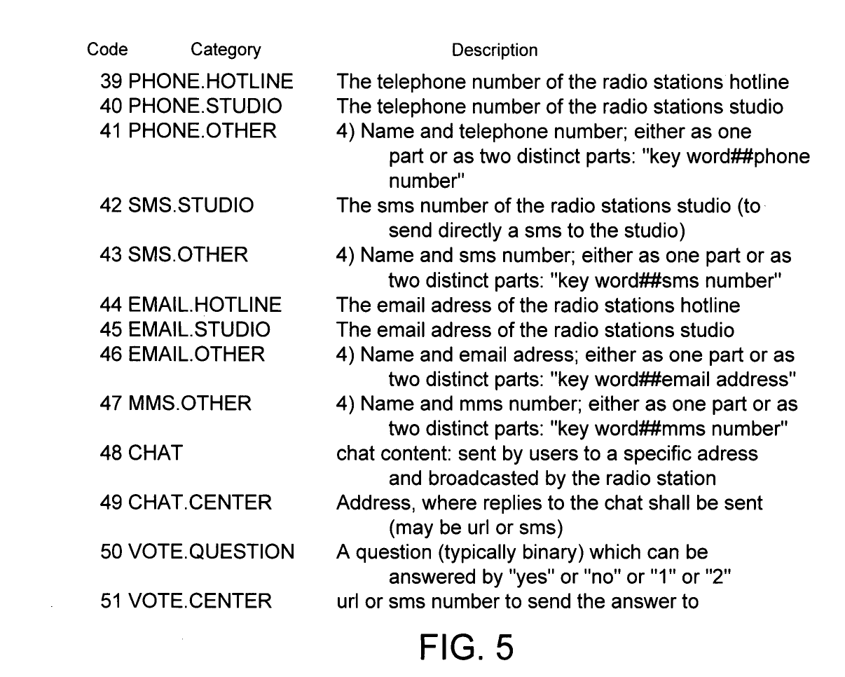

Interactivity may also be provided associated with a program. The interactivity may be described in an interactivity class of a content type. FIG. 5 illustrates an example of elements in an interactivity class, in which one or more illustrative embodiments of the invention may be implemented. For example, the interactivity class may contain information on a phone number of stations or studios or other pertinent phone numbers. The interactivity class may further include an SMS number of a station or studio, a hotline/studio e-mail address, e-mail address of other relevant party, mms number and name, chat content, return address for chat content, a question on which a view may vote, and/or a URL or SMS where the response may be sent.

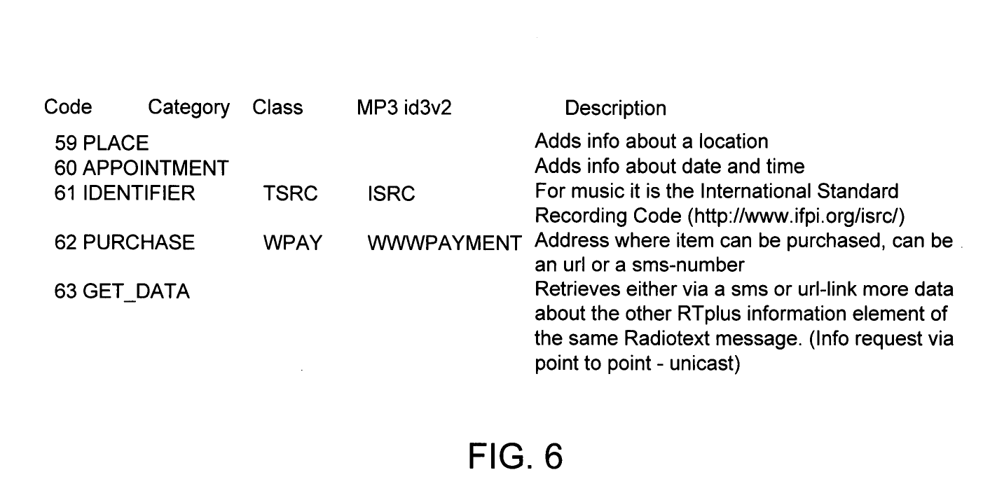

FIG. 6 illustrates another example of the content type including a descriptor class in which additional descriptive information may be provided for any class included in the content type, in which one or more illustrative embodiments of the invention may be implemented. For example, information about a location associated with the program, a time or date associated with the program, an address for purchase of items associated with the program, etc., may be provided in the descriptor class.

In addition, information may be provided in an RT+ tag in multiple parts. For example, different parts of an RT+ tag may be separated by spaces or special characters or symbols where each part provides separate information pertaining to the content. As one example, a first portion of the tag may include a key word for providing descriptive information for further characterizing the subsequent text in the RT+ tag. Examples of such RT+ tags include an RT+ tag containing a key word portion of “PHONE.OTHER” and a subsequent portion containing the corresponding phone number, or a key word portion of “SMS.OTHER” and a subsequent portion containing the corresponding SMS address, etc. Additional portions of the RT+ tag may be used separated from other parts by blanks or by special characters to provide additional information. As one example, if stock information is provided in an RT+ tag, the RT+ tag may contain a key word (e.g., “INFO.STOCKMARKET”) indicating that stock information is provided in the RT+ tag and any relevant information pertaining to a desired security following the key word and separated by the keyword by blank spaces or by special symbols (e.g., INFO.STOCKMARKET

Symbol ## Change ## Latestvalue ## High ## Low ## Volume].

RT+ data can support audio/video content. It can be used to create an on-the-fly generated content that may be used to describe the audio/video or game content on air. E.g. it would allow the broadcast of the Title/Artist info while the video clip runs. Title and Artist information and data could them be understood by the phone. Currently if MTV inserts Title/Artist info as a picture into the TV stream words or characters of Title/Artist info can not be understood as a text, string or data by the receiver (e.g. a mobile phone).

The RT+ tag may contain information on the content type in addition to other fields for describing the RT+ data. For example, the RT+ tag may include a marker for pointing to the start position of the RT message. The marker for indicating the start position may indicate the first character of the RT+ message such that a receiver may be informed about the location of the RT message. In one example, the start marker is a 6 bit value indicating the position of the first character of the RT+ tag within the RT message. Likewise, the RT+ tag may also contain a marker indicating the length of the RT+ message. In one example, the length marker may be a 6 bit value providing the length in number of characters of the RT+ tag. The length marker may further be used as a clear command for a specified content type (e.g., by setting the length marker to 0).

In an example of the invention, RT+ data and messages may be transmitted via a DVB-H network to a mobile terminal. In this example, the RT+ data may include information pertaining to a corresponding program such as a television or radio program. The RT+ data may be transmitted on an Internet Protocol, i.e., the RT+ data may be packed on a Real-Time Protocol (RTP) timed text protocol (i.e. 3 GPP timed text RTP protocol). In another example of the invention, RT+ data and messages may be transmitted and packed on a Real-Time Control Protocol (RTCP). Also, the RT+ data stream may be synchronized with the content stream of the DVB-H network (e.g., the DVB-H audio or video stream). A mobile terminal may receive the synchronized RT+ data and the audio or video data stream for display at the mobile terminal.

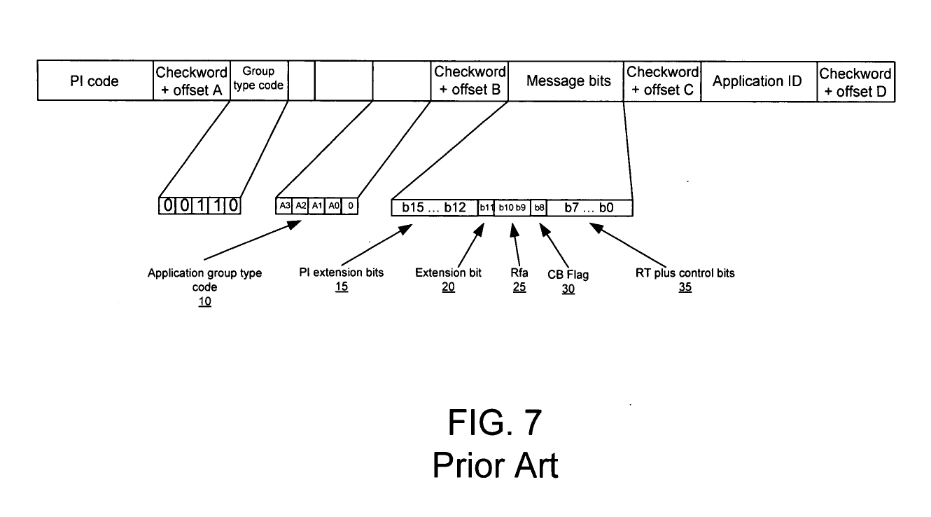

FIG. 7 illustrates an example of bit allocation for transmitting the RT+ data, in which one or more illustrative embodiments of the invention may be implemented. In this example, message bits include an application group type code 10. The application group type code 10 in this example contain five bits and is used for transmitting the group type of the RT+ data. For example, the group type may be any of the group types indicated in FIGS. 2-6. The message bits may also include Pi extension bits 15. For example, if the same PI code is used repeatedly within a region (e.g., nationally), the PE extension bits 15 may uniquely identify a data source in the region.

The message bits may include an extension bit which may indicate if additional data is broadcast on additional channels. Also, additional bits (e.g., rfa bits 25) may be provide for additional information that may be needed. Rfa bits 25 may provide additional information without affecting other bits.

A CB flag 30 or RT+ control bits 35 may also be included in the message bits. The CB flag 30 or RT+ control bits 35 in this example control the receiver in receiving or processing RT+ data. For example, a value of the CB flag 30 or RT+ control bits 35 may provide program information directly to the receiver such as title information, artist information, etc. A second value of the CB flag 30 or RT+ control bits 35 may function as a pointer for the receiver such that the receiver may download external data (e.g., data from a web server).

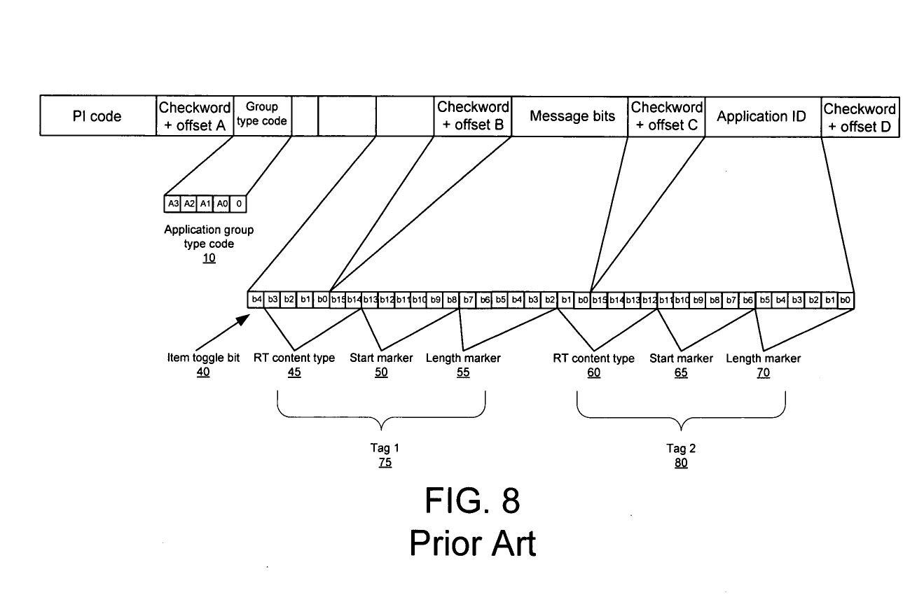

FIG. 8 illustrates an example of message bits of an RT+ application group in which a pair of RT+ tags are conveyed, in which one or more illustrative embodiments of the invention may be implemented. In this example, RT+ tags may include classes or content types such as the information illustrated in FIGS. 2-6. The message bits may include an item toggle bit 40 which may be toggled at the start of a new item. The item toggle bit 40 may further group content types of a category (e.g., an item category or class) for one item. The content types may be stored in memory or may be deleted from memory when information from a new item is stored.

The message bits may further include a pair of RT+ tags. In this example, Tag 1 75 and Tag 2 80 are included in the message bits. Tag 1 75 contains RT content type bits 45, a start marker 50 and a length marker 55. The start marker in this example is a six bit value that specifies a content type of the RT+ data. The start marker 50 indicates the position of the first character of the RT+ tag within the Radiotext. For example, a 0 value for the start marker 50 indicates the first character in the Radiotext.

As seen in the example of FIG. 8, Tag 1 75 may further include a length marker 55 for indicating the length of the RT+ tag. Also in this example, a second tag, Tag 2 80 is provided in the message bits that contains an RT content type 60, a start marker 65, and length marker 70. Either Tag 1 75 and/or Tag 2 80 may contain RT+ classes or content types. Tag 2 80 in this example may further include content types of the category descriptors which provides additional information to the content type provided in Tag 1 75. In this example, the descriptor in Tag 2 80 refers to the content type of Tag 1 75.

In an example of broadcasting of RT+ data, information may be transmitted at a predetermined frequency and the item toggle bit 40 may be toggled when the information or Radiotext data changes. RT+ information corresponding to an application group may be transmitted to an encoder immediately after Radiotext of the application group is received. In addition, data may be transmitted over DVB channels. In this example, an ancillary data field may be used such that information may be decoded and displayed in a DVB set top box.

A receiver or mobile terminal may receive the Radiotext. For example, a Radiotext flag may be received indicating a new message. When the Radiotext is received, the RT+ content corresponding to the Radiotext may be decoded. RT+ information may be stored and may be displayed, for example when a user recalls the content type.

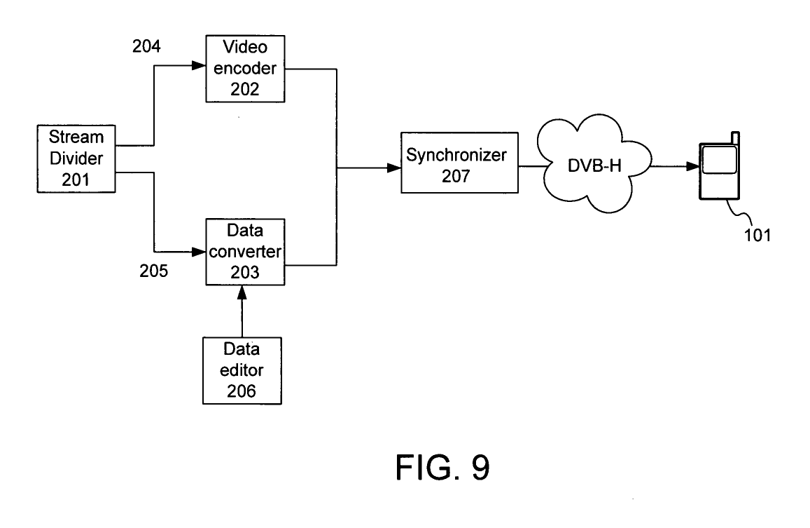

FIG. 9 is a partial block diagram illustrating an example of a system for transmitting RT+ data over a digital TV transmission, such as the DVB-H, to a user terminal, e.g. a mobile terminal, in which one or more illustrative embodiments of the invention may be implemented. In this example, the system includes a stream divider 201 for receiving a data stream from a data source (e.g., a television or radio broadcasting data source). The data source provides a content stream that may include an audio/video stream and associated RT+ data stream. One example of a content stream includes a DVB-S data stream containing RT+ metadata. The stream divider 201 in this example extracts the RT+ data from the DVB-S transport stream. Other examples of digital television contents streams are such as DVB-T, DVB-C, DMB, MediaFlo, etc.

Hence, the stream divider 201 may divide the content stream from the program source into an audio/video stream(s) 204 and an RT+ data stream 205. A video encoder may receive the audio/video stream 204 from the stream divider 201 for encoding the data. Alternatively, a program source may send the audio/video stream 204 separately from RT+ data such that the program source may transmit the audio/video stream 204 directly to the video encoder 202, not shown in the Figure. The video encoder 202 encodes the input audio/video stream 204 on the Internet Protocol (IP) and transmits the audio/video data on IP via a DVB-H network to a mobile terminal. The RT+ data stream 205 may be only in a format of RT+ data (i.e. separate from RDS) or alternatively the stream 205 may be RDS stream including content in RT+ format. Alternatively, the program source or a RT+ data content source may send the RT+ data 205 separately from the audio/video stream 204 to the data editor 206, or alternatively directly to a data converter 203, not shown in the Figure.

As described, the RT+ data stream 205 is delivered to the data converter 203. The data converter 203 may convert the RT+ data 205 into Real-Time protocol (RTP) data to pack the RT+ data on an Real-Time Protocol (RTP) timed text protocol. For example, RT+ data may be sent in alternative formats: 1) RT+ descriptions in text or data format, or 2) RDS in binary UECP format. RT+ data may be sent over RTP protocol in alternative ways: a) in a separate RTP stream such as 3GPP (3rd Generation Partnership Project) Timed Text stream, or b) included in the control protocol (RTCP) of an RTP stream as application-specific (APP) packets. The way b) may be useful if there are just a little RT+ text/data because the RTCP control packets can be extended for this kind of data, in other words, no separate data converter 203 may not be needed in this case. In the case a) the RT+ over the separate RTP stream may be delivered over DVB-H data stream parallel with DVB-H audio/video streams, and in the case b) RT+ included in the RTCP may delivered over/inside DVB-H audio or video stream. In another example, the RT+ data may be delivered over/inside of two or more data streams by the RTP or the RTCP, e.g. in any combinations of DVB-H audio, video and data streams. This may become necessary e.g. if different RT+ language content is needed to be delivered. In one example, the data converter 203 may be a file cast server. The data converter 203 outputs the RT+ data on IP (i.e., the RT+ data packed on RTP) and transmits the RT+ data on RTP to a mobile terminal via a DVB-H network. RT data may be integrated with the audio/video data stream and data bits may be assembled in the final synchronized data stream in the DVB-H in a variety of ways. For example, RT+ descriptions may be included as such in text format in 3GPP timed text RTP payload. Alternatively, RDS in binary UECP may be included in an RTCP APP packet. In addition, the system may include a data editor 206 for providing information to be included in the RT+ data. For example, the data editor 206 may include title information or artist information that may be included in RT+ data via the data converter 203. For example, the data editor may add new information or may modify existing RT information.

Hence, in this example, program information may be transmitted to a mobile terminal via DVB-H and may be received and displayed at the mobile terminal. The program information may be provided in RT+ messages and may include, for example, program information title, information, track information, artist information, album information, news or alerts, advertisements, interactive elements, voting services, etc. A/V data and RT+ data may be sent in different IP packets or streams. RTP specification may define how different RTP streams are synchronized together. Also, the received RT+ data may be used in searching, filtering, and indexing corresponding audio/video data.

The audio/video on IP stream from the video encoder 202 is transmitted over the DVB-H network to the mobile terminal and the corresponding RT+ data on IP (i.e., RTP) is transmitted over DVB-H to the mobile terminal as described. The RT+ data stream may be placed on top of the IP and the audio/video on IP stream may be synchronized with the corresponding RT+ data on IP in the DVB-H. In the synchronization process, the RTP specification may define how different RTP streams (e.g., audio, video, data) are synchronized. Each RTP stream may have an associated control stream (RTCP). RTCP packet synchronizes the associated RTP stream to a wall-clock time.

RTP packets have a timestamp with a random initial value. RTP control protocol (RTCP) packets are sent repeatedly with RTP packets. The RTCP packet maps the latest RTP packet timestamp to wall-clock time. The receiver first receives RTP packets for each RTP streams (e.g. audio and video). These packets may not be synchronized directly together because, for example, buffering times may vary for audio and video (may be several seconds out-of-sync), or because the RTP timestamps have random initial values. Once the first RTCP packets are received for both audio and video, both audio RTP timestamp and video RTP timestamp are synchronized with the wall-clock time, and hence audio and video are synchronized together. As the example of FIG. 9 illustrates, a synchronizer 207 may be provide for synchronizing the RT+ data on IP in the DVB-H. Synchronization may be accomplished in a variety of ways which may depend on the accuracy desired. In one example, both the audio/video stream on IP and the RT+ data stream on IP contain time stamps corresponding to real-time (i.e., “wall clock time”). In this case, the respective clocks in each of the video encoder 202 and the data converter 203 are synchronized in the synchronizer 205 such that the audio/video stream on IP from the video encoder 202 and the RT+ data on IP from the data converter 203 are synchronized at the mobile terminal 101.

In another example in which precise synchronization is desired between the audio/video stream on IP from the video encoder 202 and the RT+ data on IP from the data converter 203, time stamps may be inserted into each of the respective data streams. For example, time stamps according to the Real Time Control Protocol (RTCP) may be used such that each generator associated with each data stream is defined to insert the respective time stamp packets. In this example, the clocks associated with each of the generators corresponding to the data streams are synchronized by the synchronizer 207.

In another example, the RT+ data stream 205 may be received directly from a RT+ content server. For example, a service editor may create a service including a combination of an audio/video stream and corresponding RT+ data stream. The service may be created by the service editor, for example, by an RT+ data editor device. In addition a time stamp may be placed in the RT+ data content and/or the corresponding audio/video stream for synchronization of the stream. The service editor may comprise all or any combination of the following part, such as the video encoder 202, the data converter 203, the data editor 206, the synchronizer 207, and the stream devider 201. Further, the aforementioned elements may directly connected between each other (not shown in the FIG. 9).

In another example, the RT+ data may be carried in the DVB-H video/audio stream. In this example, the audio/video data stream 204 may be transmitted to the video encoder 202 with the RT+ data stream 205. Hence, in this example, the data converter 203 may be omitted as there is no separate RT+ data to RTP conversion necessary.

The mobile terminal may receive by the DVB-H audio/video data on IP and the RT+ data on IP (RTP) and may present the received data in a synchronized fashion at the mobile terminal. Also, the mobile terminal may further contain a user interface controller for creating a user interface through which information or instructions may be entered. The information or instructions entered via the user interface may further control the RT+ data stream.

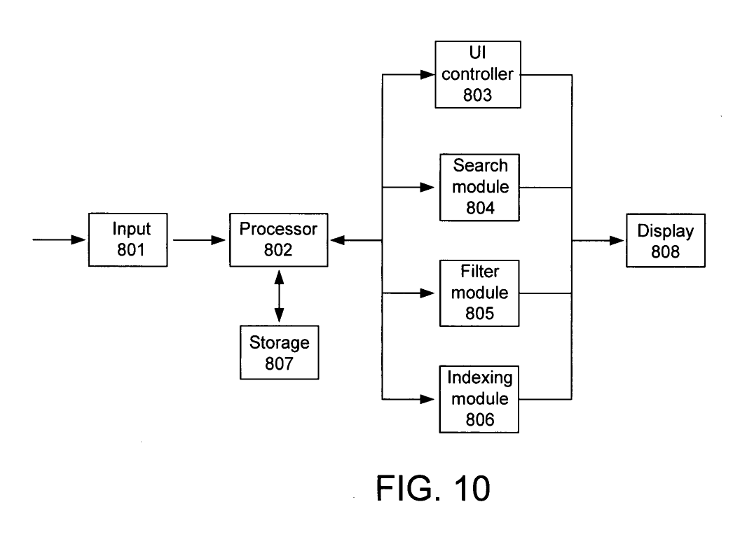

FIG. 10 is a partial block diagram illustrating an example of a receiver or mobile terminal, in which one or more illustrative embodiments of the invention may be implemented. The receiver illustrated in FIG. 10 includes an input 801 for receiving program data in audio/video data in a DVB-H data stream and an RTP (i.e., RT+ data stream corresponding to program data). The data stream is processed in the processor 802 which may identify the content type contained in the RT+ data, for example, either identified in an SDP file of an ESG in a separate RTP stream or in an application defined packet such as audio RTCP APP. Also, the processor 802 may synchronize the received program data in the audio/video data in a DVB-H data stream and the corresponding RT+ data received. Hence, the receiver may provide the information from the audio/video data in a DVB-H data stream in a synchronized manner on the display 808. The receiver may be implemented in a mobile phone, a PDA, an audio or a video device, in a digital camera or camcorder, a mobile or desktop television, a laptop or desktop PC, a digital or analog radio, a GPS device, or in a device of any combination of the aforementioned.

Generally, an Electronic Service Guide (ESG) enables a terminal to communicate what services are available to end users and how the services may be accessed. The ESG consists of independently existing pieces of ESG fragments. Traditionally, ESG fragments comprise XML documents, but more recently they have encompassed a vast array of items, such as for example, a SDP (Session Description Protocol) description, textual file, or an image. The ESG fragments describe one or several aspects of currently available (or future) service or broadcast program. Such aspects may include for example: free text description, schedule, geographical availability, price, purchase method, genre, and supplementary information such as preview images or clips. Audio, video and other types of data comprising the ESG fragments may be transmitted through a variety of types of networks according to many different protocols. For example, data can be transmitted through a collection of networks usually referred to as the “Internet” using protocols of the Internet protocol suite, such as Internet Protocol (IP) and User Datagram Protocol (UDP). Data is often transmitted through the Internet addressed to a single user. It can, however, be addressed to a group of users, commonly known as multicasting. In the case in which the data is addressed to all users it is called broadcasting.

One way of broadcasting data is to use an IP datacasting (IPDC) network. IPDC is a combination of digital broadcast and Internet Protocol. Through such an IP-based broadcasting network, one or more service providers can supply different types of IP services including on-line newspapers, radio, and television. These IP services are organized into one or more media streams in the form of audio, video and/or other types of data. To determine when and where these streams occur, users refer to an electronic service guide (ESG). One example used in digital video broadcasting (DVB) streams is an electronic program guide (EPG). One type of DVB is Digital video broadcasting-handheld (DVB-H). The DVB-H is designed to deliver 10 Mbps of data to a battery-powered terminal device.

DVB transport streams deliver compressed audio and video and data to a user via third party delivery networks. Moving Picture Expert Group (MPEG) is a technology by which encoded video, audio, and data within a single program is multiplexed, with other programs, into a transport stream (TS). The TS is a packetised data stream, with fixed length packets, including a header. The individual elements of a program, audio and video, are each carried within packets having a unique packet identification (PID). To enable a receiver device to locate the different elements of a particular program within the TS, Program Specific Information (PSI), which is embedded into the TS, is supplied. In addition, additional Service Information (SI), a set of tables adhering to the MPEG private section syntax, is incorporated into the TS. This enables a receiver device to correctly process the data contained within the TS.

As stated above, the ESG fragments may be transported by IPDC over a network, such as for example, DVB-H to destination devices. The destination device must then again determine the ordering of the ESG fragments and assemble them into useful information.

In one embodiment, the ESG provides basic program related information or main service related information. RT+ data may be used to provide information in addition to information in the ESG. The RT+ data content may also be provided in real-time and interactively. For example, the RT+ data feed may provide the ESG content which may also be provided in DVB-H including separate audio, video and data streams.

Also, based on the content of the RT+ data, as described e.g. in the FIGS. 2-6, the receiver may provide a corresponding user interface (UI) through which synchronized data may be provided. For example, the receiver may include a UI controller 803. An RT+ data stream may be received at the input 801 and may contain information or instructions for creating a UI. The information or instructions for creating the UI may be identified in the processor 802 which may control the UI controller 803 to create a corresponding UI based on the received information or instructions. For example, the UI controller 803 may create a UI in which a user may enter messages or vote on issues associated with the program. Also, the RT+ data may include information or display such as title of the program, track information, artist information, news, alerts, advertisements, interactive elements (e.g., phone, SMS, MMS, e-mail, chat, voting, etc.). Any of this information may be displayed on the display 808.

In addition, the RT+ data received at the input 801 may include control messages for the layout of the UI at the receiver. The processor 802 may identify the control messages and the UI controller 803 may create a UI based on the control messages received in the RT+ data to provide a rich media environment.

In another example, the data received at the input 801 may be stored in a storage 807. The stored data may be used subsequently for additional data processing. For example, stored data may be searched, filtered or indexed. As the example of FIG. 10 illustrates, the receiver may include a search module 804 which may search for information stored in storage 807 based on desired features. In one example, a user may input a desired search parameter into the receiver (e.g., via an interactive UI on the display 808). The search module 804 receives the search parameter and based on the search parameter, the search module 804 may search the storage 807 for the desired data. Alternatively, the RT+ data received at the input 801 may also contain a search control. The storage 807 may be searched based on the search control of the RT+ data.

Also, the receiver may include a filter module 805 for filtering data. For example, data in the storage 807 may be retrieved and may be filtered by the filter module 805 to include only data of relevance or data corresponding to a desired feature. Likewise an indexing module 806 may be provided in the receiver for indexing data. For example, data in storage 807 may be retrieved and may be indexed by the indexing module 806.

In another example, a computer-readable medium is provided having instructions stored thereon for transmitting program data in a DVB-H stream and synchronizing the program data with RT+ data on IP (i.e., RTP). The synchronized data is provided to a mobile terminal.

In another example, a small amount of RT+ data is used. For examples if there is just a small amount of RT+ data, the RT+ data can be carried inside of a DVB-=H audio/video stream. RTCP control packets can be extended for this kind of data. Hence, a separate RT+ data to RTP converter is not needed.

A user of a mobile phone & TV terminal receives DVB-H/RT+ data broadcasting comprising a content of an actual TV program, such as a music show, and related supplemental information. The supplemental information may solicit the user to call or contact into a show, to vote, or to purchase products related to the program, like songs, albums or artist/band related products. The broadcasting with RT+ data may provide information and/or an active link for the contact and purchase which may include a telephone number (such as PHONE.HOTLINE, PHONE.STUDIO, PHONE.OTHER), an email address (such as EMAIL.HOTLINE, EMAIL.STUDIO, EMAIL.OTHER), an IP address (such as PURCHASE, INFO.URL), a URL (such as PURCHASE, INFO.URL), an SMS/MMS message address (such as SMS.STUDIO, SMS.OTHER, MMS.OTHER), or the like. Further, the broadcasting with RT+ data may provide information on the products itself, like a title of a song, (ITEM.TITLE), a name of an album (ITEM.ALBUM), a name of the artist (ITEM.ARTIST), a name of the band (ITEM.BAND). The supplemental information, such as the contact and/or product information may be displayed on the TV display of the user terminal along with the actual TV program. The supplemental information may be displayed on an over layer of the TV programs, or it may be displayed in a separate frame or window on the same display. Alternatively, the supplemental information may be displayed on a separate display. The supplemental information may be static or dynamic, and it may be stored in the device for later retrieval. The supplemental information may be presented in a synchronized manner relating to the program, or it may be displayed immediately after receiving. A presentation form of the supplemental content may be decided by the terminal and/or suggested by the RT+ data. The user receiving the content of the program may decide to create an access to the show, or to purchase the advertised products by selecting an appropriate link in their mobile phone & TV terminal. The access to the show or purchasing service is created via the wireless communication back channel, such as wireless telecom access, WLAN, Bluetooth etc. In some cases, the supplemental content may be displayed and/or transmitted without actual program content.

The embodiments herein include any feature or combination of features disclosed herein either explicitly or any generalization thereof. While the invention has been described with respect to specific examples including presently preferred modes of carrying out the invention, those skilled in the art will appreciate that there are numerous variations and permutations of the above described systems and techniques.

We claim:

1. A method of transmitting radiotext plus data corresponding to a service to a terminal comprising:
receiving radiotext plus data; and
transmitting the radiotext plus data to a user terminal,
wherein the radiotext plus data is transmitted to the user terminal in a Digital Video Broadcast—Handheld (DVB-H) stream.

2. The method of claim 1 wherein the transmitting comprises converting the radiotext plus data to Real-Time Transport Protocol (RTP).

3. The method of claim 2 wherein the converting comprises packing the radiotext plus data on an RTP timed text protocol.

4. The method of claim 1 further comprising synchronizing the radiotext plus data with the service data in the DVB-H stream.

5. The method of claim 4 further comprising inserting a first time stamp in the service data and inserting a second time stamp in the radiotext plus data.

6. The method of claim 1 wherein the receiving step comprises:
receiving a data stream comprising program data and corresponding radiotext plus data; and
dividing the data stream into at least a first component and a second component.

7. The method of claim 6 wherein the first component comprises service data corresponding to the service and the second component comprises the radiotext plus data.

8. The method of claim 7 further comprising encoding the service data on the Internet Protocol (IP) and transmitting the program data on IP in the DVB-H stream to the mobile terminal.

9. The method of claim 8 further comprising converting the radiotext plus data to a Real-Time Protocol (RTP).

10. The method of claim 9 wherein the converting comprises packing the radiotext plus data on a Real-Time Protocol (RTP) timed text protocol.

11. The method of claim 9 further comprising synchronizing the radiotext plus data with the program data on IP in the DVB-H stream.

12. The method of claim 1 wherein the radiotext plus data comprises information selected from the group consisting of program, title, track artist, album, news, alerts, advertisements, and interactive elements.

13. The method of claim 1 wherein the radiotext plus data comprises information on interactive elements.

14. An apparatus for transmitting radiotext plus data corresponding to a service comprising:
an encoder for encoding the service data corresponding to the service in a DVB-H stream; and
a data converter for converting the radiotext plus data to RTP, the data converter further synchronizing the radiotext plus data with the service data in the DVB-H stream.

15. The transmission system of claim 14 further comprising a stream divider for receiving a data stream comprising the program data and the radiotext plus data and dividing the data stream into at least a first component and a second component.

16. The transmission system of claim 15 wherein the first component comprises the program data and the second component comprises the radiotext plus data.

17. An apparatus for receiving radiotext data corresponding to a DVB-H stream comprising:
a receiver for receiving the DVB-H stream comprising service data and corresponding radiotext plus data;
a processor for identifying data in the radiotext plus data;
a processor for synchronizing the service data and the corresponding radiotext plus data; and
a display for displaying content based on the radiotext plus data with the service data.

18. The receiver of claim 17 further comprising a storage for storing the radiotext plus data.

19. The receiver of claim 18 further comprising a module for processing the stored radiotext plus data.

20. The receiver of claim 19 wherein the module comprises a search module for retrieving data from the storage.

21. The receiver of claim 19 wherein the module comprises a filter module for retrieving data corresponding to a search parameter.

22. The receiver of claim 19 wherein the module comprises an indexing module for organizing data from the storage.

23. The receiver of claim 17 further comprising a control unit for creating a user interface.

24. The receiver of claim 23 wherein the processor identifies a parameter in the radiotext plus data and the control unit creates the user interface based on the parameter.

25. A computer-readable medium comprising computer-readable instructions for performing the steps of:
transmitting service data in a Digital Video Broadcast—Handheld (DVB-H) stream;
transmitting radiotext plus data on Internet Protocol (IP) in a radiotext plus data stream, the radiotext plus data corresponding to the service data;
synchronizing the radiotext plus data stream with the service data in the DVB-H stream; and
delivering the radiotext plus data to a mobile terminal.

26. A method for transmitting radiotext plus data over Digital Video Broadcast—Handheld (DVB-H) stream, comprising:
converting the radiotext plus data to a Real Time Protocol (RTP) data stream;
combining the RTP data stream with the radiotext plus data to a data stream of the DVB-H stream;
transmitting the DVB-H stream with the combined DVB-H data stream.

27. A method for transmitting radiotext plus data over a DVB-H stream, comprising:
converting the radiotext plus data to Real Time Control Protocol (RTCP) data stream;
combining the RTCP data stream with the radiotext plus data to an audio or visual stream of the DVB-H stream; and
transmitting the DVB-H stream with the combined DVB-H audio or visual stream.
